(19) United States
(12) Patent Application Publication
(10) Pub. No.: US 2020/0041978 A1
(43) Pub. Date: Feb. 6, 2020

(54) Providing a User Surface for Monitoring and/or Controlling a Packaging System

(71) Applicant: SIG Technology AG, Neuhausen am Rheinfall (CH)

(72) Inventors: Thomas Hofmann, Osnabrueck (DE); Tim-Niklas Hachmeister, Minden (DE); Jawaher Hamo, Osnabrueck (DE); Nikolaj Freitag, Dueren (DE); Wolfram Peters, Bergheim (DE)

(21) Appl. No.: 16/605,976

(22) PCT Filed: Apr. 17, 2018
(86) PCT No.: PCT/EP2018/059710

§ 371 Date: Oct. 17, 2019

(30) Foreign Application Priority Data
Apr. 21, 2017 (DE) 10 2017 108 547.5

(51) Int. Cl. G05B 19/409; G06T 11/20; B65B 57/00; B67C 3/00

(52) U.S. Cl. CPC G05B 19/409; G06T 11/206; B65B 57/00; G06F 3/04847; G05B 2219/36133; G05B 2219/37078; G05B 2219/45048; B67C 3/007

(57) ABSTRACT

A method is, inter alia, disclosed, which comprises the following: providing a graphic user surface for monitoring and/or controlling a packaging system, wherein the graphic user surface comprises a production parameter course view for displaying one or a plurality of predefined production parameters of the packaging system, wherein the production parameter course view for each of the predefined production parameters graphically represents at least one course of the respective production parameter in a previous time period and the respective current production parameter value, wherein the graphic user surface further comprises at least one alternative view that can be activated and wherein the production parameter course view and the alternative view are configured such that the alternative view is displayed when the alternative view is activated in such a way that the alternative view only partially covers the production parameter course view and a first section of the production parameter course view is displayed with the graphic representations of the current production parameter values of the predefined production parameters.

### FIELD

Exemplary embodiments of the invention relate to monitoring and/or controlling a packaging system, in particular providing a user surface to monitor and/or control a packaging system.

### BACKGROUND

Packaging systems such as for example systems for packaging goods such as for example foodstuffs are known. These system are often monitored or controlled by a single user, wherein current production parameter values of production parameters of the packaging system for example are displayed to the user by corresponding graphic user interface e.g. in the form of bar graphs, scale displays and/or numeric displays. These displays are frequently unclear and not user-friendly and cannot be displayed or only displayed with difficult by the graphic user interfaces, delimited in the external dimensions, of portable device. In particular in connection with monitoring and controlling packaging systems, it is (unlike other production systems) particularly difficult owing to the numerous possible components of such a packaging system to provide a clear and user-friendly display of the production parameters.

### SUMMARY OF SOME EXEMPLARY EMBODIMENTS OF THE INVENTION

The object of the present invention was therefore to overcome one or more of the above-described disadvantages and for example to provide a solution to the clear and user-friendly display of production parameters of a packaging system.

According to the invention, a method is disclosed comprising the following:
providing a graphic user surface for monitoring and/or controlling a packaging system, wherein the graphic user surface comprises a production parameter course course view for displaying one or a plurality of predefined production parameters of the packaging system, wherein the production parameter course view for each of the predefined production parameters graphically represents at least one course of the respective production parameter in a previous time period and the respective current production parameter value, wherein the graphic user surface further comprises at least one activatable alternative view and wherein the production parameter course view and the alternative view are configured such that the alternative view is displayed when the alternative view is activated in such a way that the alternative view only partially covers the production parameter course view and a first section of the production parameter course view is (e.g. still) displayed with the graphic representations of the current production parameter values of the predefined production parameters.

The method according to the invention is for example a method for monitoring and/or controlling the packaging system or a part of such a method.

Furthermore, according to the invention, a computer program is disclosed that comprises program instructions that cause a processor to perform and/or control the method according to the invention when the computer program is executed by the processor. Either all of the steps in the method can be controlled, or all of the steps in the method can be performed, or one or more steps can be controlled and one or more steps performed.

The computer program can for example be shareable via a network such as the internet, a telephone or mobile communications network and/or a local network. The computer program can be at least in part software and/or firmware of a processor. It may be implemented at least partially as hardware.

The computer program is for example contained and/or stored on a computer-readable storage medium. A physical and/or tangible storage medium is for example understood as a computer-readable storage medium.

The computer program is for example a computer program for monitoring and/or controlling the packaging system.

Furthermore, according to the invention, an apparatus is disclosed configured to perform and/or control the method according to the invention or comprising respective means to perform and/or control the steps of the method according to the invention. Either all of the steps of the method according to the invention could be controlled by the means, or all of the steps of the method according to the invention could be performed by the means, or one or more steps can be controlled by the means and one or more steps can be performed by the means. Various steps can optionally be performed or controlled by various means.

The means of the disclosed apparatus can comprise hardware and/or software components. The means can for example comprise a memory with program instructions for a computer program (e.g. the computer program according to the invention) and at least one processor configured to execute program instructions from the at least one memory. Correspondingly, according to the invention, at least one apparatus should be understood to be disclosed which comprises at least one processor and at least one memory with program instructions, wherein the at least one memory and the program instructions are configured to cause, together with the at least one processor, the apparatus to perform and/or to control the method according to the invention.

In addition, the disclosed apparatus can comprise additional means such as for example a communication interface (e.g. to send and/or receive information) and/or a user interface (e.g. a graphic user interface).

The apparatus is for example an apparatus for monitoring and/or controlling the packaging system.

Furthermore, according to the invention, a system is disclosed that comprises the following:
an apparatus according to the invention; and
a packaging system.

The properties and features of the method according to the invention, the computer program according to the invention, the apparatus according to the invention and the system according to the invention are described below, in some cases by means of an example.

The graphic user surface for monitoring and/or controlling the packaging system is for example a graphic user surface of a computer program to monitor and/or control the packaging system (e.g. of the computer program according to the invention).

Providing the graphic user surface should for example be understood as the graphic user surface being provided by a graphic user interface (e.g. a graphic user interface of the apparatus according to the invention) by the graphic user interface being controlled such that it displays at least a part of the graphic user surface (e.g. the production parameter course view).

The graphic user surface can comprise different views and elements, which can be displayed at least partially at the same time as part of the graphic user surface. It is understood that at least in some embodiments at least some views and elements of the user surface can be displayed only alternatively as part of the user surface. In this case, the views and elements of the graphic user surface should for example be understood as displayed when they are visible to a user (e.g. are visibly displayed to a user by a graphic user interface).

The production parameter course view is for example displayed in a part of the graphic user surface (e.g. in a window of the graphic user surface). Additional elements (e.g. a task list and/or a status list) can still be displayed as part of the user surface at the same time as the production parameter course view.

The production parameter course view serves to display one or a plurality of predefined production parameters of the packaging system.

A system for packaging goods such as for example foodstuffs is understood by a packaging system. In particular, a packaging system should be understood to mean a beverage filling system and/or a part of a beverage filling system. A large number of different components are frequently used in such systems, for example heating systems (for example heating systems for ultra-high heating of the filled product), filling machines, applicators for attaching closures and/or beverage straws, switch points, case packers and cartoners. Various applications run on these components (e.g. in the form of a computer program run by a processor of these components).

A production parameter of the packaging system is for example a parameter characteristic of the status of the packaging system and/or a production process performed by the packaging system. Examples of such production parameters are for example a filling quantity per package, a temperature (e.g. a temperature of the filling material), a fill status or a fill level (e.g. in percent; e.g. a fill status of a packaging material magazine of the packaging system or a fill level of a product tank such as a filling material tank of the packaging system), a total system performance of the packaging system and/or a performance of one or a plurality of components of the packaging system (e.g. in number of the packages processed by the packaging system and/or the component(s) per hour), a pressure (e.g. in mbar or bar; e.g. the pressure of a pressurised air supply of the packaging system and/or of a component of the packaging system), a flow (e.g. in ml or l per min or s; e.g. the flow of a cooling fluid in a cooling device of the packaging system), a time specification (e.g. in ms or s or min; e.g. an indication of the remaining time of an ongoing process such as a cleaning process of the packaging system and/or of a component of the packaging system) and/or a volume (e.g. in ml or l; e.g. the volume of the filling material remaining in a product tank such as a filling material tank of the packaging system).

A course of a production parameter represents for example a development of the respective production parameter in a predefined time period (e.g. a predefined previous time period).

For example, the predefined production parameters and/or the predefined previous time period can be predefined and/or adjusted at least partially by a user. Alternatively or additionally, the predefined production parameters and/or the predefined previous time period can be at least partially fixedly predefined (i.e. be unchangeably predefined for a user).

A respective representation of the predefined production parameters and/or the predefined previous time period is for example stored in a memory (e.g. in a memory of the apparatus according to the invention).

The production parameter course view comprises for example as a graphic representation a course diagram which represents (e.g. graphically represents) the courses of the predefined production parameters in the predefined previous time period and the current production parameter values of the predefined production parameters. For example, the different courses are represented in the course diagram as overlapping course curves with a common X-axis.

As a result, the different predefined production parameters and their development in a common view are displayed to the user such that the user no longer has to switch back and forth between different scale and numeric displays. This is for example advantageous in order to enable a clear and user-friendly display of the production parameter course view, for example also by way of graphic user interfaces of portable devices. The user can also identify for example an unusual trend or outlier in the course of a production parameter through this view without him for example having to previously notice production parameter values recorded for a production parameter.

In addition to the production parameter course view, the graphic user surface also comprises at least one activatable alternative view. The activatable alternative view serves for example to display information and/or to provide user input interfaces for monitoring and/or controlling the packaging system. It is understood that the alternative view can display different information and/or provide different user input interfaces. For example, the alternative view can be activated in order to display diagnostic information of one or a plurality of components of the packaging system and/or in order to provide user input interfaces to control one or a plurality of components of the packaging system.

For example, the alternative view can be activated by a user.

For example, the production parameter course view is displayed as part of the user surface as default and the alternative view is displayed for example only as part of the user surface when it is activated.

The alternative view only partially covering the production parameter course view and the first section of the production parameter course view (e.g. still) being displayed with the graphic representations of the current production parameter values of the predefined production parameters when the alternative view is activated, should for example be understood such that the alternative view and at least the first section of the production parameter course view are displayed at the same time as part of the graphic user surface.

The graphic representation of the current production parameter values of the predefined production parameters is for example located in the first section of the production parameter course view.

This is for example advantageous in order to give the user the option, when the alternative view is activated, to record and continue to monitor at a glance at least the current status of the packaging system in the form of the current production parameter values of the predefined production parameters. As a result, the user can react particularly quickly to status changes, if this is required.

Further properties and features of the method according to the invention, the computer program according to the invention, the apparatus according to the invention and the system according to the invention are explained below using exemplary embodiments of the invention.

According to an exemplary embodiment of the invention, the method further comprises the following:
displaying and/or causing to display the alternative view as part of the graphic user surface.

For example, the alternative view is only displayed as part of the graphic user surface and/or displaying of the alternative view is only caused when the alternative view is activated. As disclosed above, the production parameter course view can be displayed as part of the user surface as default and the alternative view is displayed for example only as part of the user surface when it is activated.

As disclosed above, the alternative view serves for example to display information and/or to provide user input interfaces for monitoring and/or controlling the packaging system.

Displaying the alternative view as part of the graphic user surface takes place for example by way of a graphic user interface (e.g. a graphic user interface of the apparatus according to the invention). Causing to display the production parameter course view as part of the graphic user surface should for example be understood as the graphic user interface being controlled such that it displays the alternative view as part of the graphic user surface.

The alternative view being displayed as part of the graphic user surface should for example be understood such that additional elements and/or views are still displayed as part of the graphic user surface at the same time as the alternative view. For example, at least the first section of the production parameter course view can be displayed as part of the graphic user surface at the same time as the alternative view. As disclosed above, the views and elements of the graphic user surface should for example be understood as displayed when they are visible to a user (e.g. are visibly displayed to a user by a graphic user interface).

According to an exemplary embodiment of the invention, the alternative view is only displayed as part of the user surface when it is activated.

According to an exemplary embodiment of the invention, the method further comprises the following:
displaying and/or causing to display the production parameter course view and/or the first section of the production parameter course view as part of the graphic user surface.

As disclosed above, the production parameter course view can be displayed as part of the user surface as default and the alternative view is displayed for example only as part of the user surface when it is activated.

Accordingly, the production parameter course view is for example displayed as part of the graphic user surface and/or displaying of the production parameter course view is caused when the alternative view is deactivated. In this case, displaying and/or causing to display the production parameter course view should for example be understood such that the production parameter course view is fully displayed and/or its full display is caused.

Only the first section of the production parameter course view is also for example displayed as part of the graphic user surface and/or displaying of the first section of the production parameter course view is caused when the alternative view is activated. In this case, the first section of the production parameter course view for example represents only a part of the full production parameter course view.

Displaying of the production parameter course view and/or the first section of the production parameter course view as part of the graphic user surface takes place for example by way of a graphic user interface (e.g. a graphic user interface of the apparatus according to the invention). Causing to display the production parameter course view and/or the first section of the production parameter course view as part of the graphic user surface should for example be understood as the graphic user interface being controlled such that it displays the production parameter course view and/or the first section of the production parameter course view as part of the graphic user surface.

The production parameter course view being displayed as part of the graphic user surface should for example be understood such that additional elements and/or views are still displayed as part of the graphic user surface at the same time as the production parameter course view. As disclosed above, the views and elements of the graphic user surface should for example be understood as displayed when they are visible to a user (e.g. are visibly displayed to a user by a graphic user interface).

According to an exemplary embodiment of the invention, at least the first section of the production parameter course view is permanently displayed as part of the user surface. This can for example be achieved in that the section of the production parameter course view is displayed both as part of the user surface when the alternative view is activated and also when the alternative view is deactivated.

According to an exemplary embodiment of the invention, the first section of the production parameter course view is located outside of the centre of the graphic user surface.

The first section of the production parameter course view being located outside of the centre of the graphic user surface should for example be understood such that, when at least the first section of the production parameter course view is displayed as part of the user surface by a graphic user interface, the centre of the graphic user surface lies outside of the area taken up by the first section of the production parameter course view on the graphic user interface.

In this case, the centre of the graphic user surface should for example be understood as the geometric focal point of the graphic user surface, for example the geometric focal point of the area taken up by the graphic user surface on a graphic user interface, which provides and/or displays the graphic user surface. Accordingly, when the graphic user surface for example takes up a rectangular area on the graphic user interface, the point of intersection of the diagonals of the rectangular area (i.e. of the rectangle formed by the rectangular area) should be understood as the centre of the graphic user surface.

According to an exemplary embodiment of the invention, the production parameter course view extends at least in a direction from a side delimitation of the graphic user surface to an opposing side delimitation of the graphic user surface. This should for example be understood in that the production parameter course view extends at least accordingly when it is fully displayed.

In this case, for example a side of the area taken up by the graphic user surface on a graphic user interface, which provides and/or displays the graphic user surface, should be understood as a side delimitation of the graphic user surface. Accordingly, the production parameter course view can for example, when the graphic user surface for example takes up a rectangular area on the graphic user interface, extend from one side of the rectangular area (i.e. of the rectangle formed by the rectangular area) to the opposing side of the rectangular area in a direction running perpendicular to at least one of the two sides and/or parallel to the two other sides of the rectangular area.

For example, the production parameter course view takes up a rectangular area on a graphic user interface which displays the production parameter course view as part of the graphic user surface.

According to an exemplary embodiment of the invention, the alternative view extends at least in a direction from a side delimitation of the graphic user surface to the first section of the production parameter course view. This should for example be understood such that the production parameter course view extends at least accordingly when it is activated and/or displayed.

In this case, for example a side of the area taken up by the graphic user surface on a graphic user interface, which provides and/or displays the graphic user interface, should be understood as a side delimitation of the graphic user surface. For example, the alternative view extends from one side of the area taken up by the graphic user surface on a graphic user interface to the nearest side of the area taken up by the first section of the production parameter course view on the graphic user surface. Accordingly, the production parameter course view can for example extend, when the graphic user surface and the first section of the production parameter course view for example in each case take up a rectangular area on the graphic user interface, from one side of the rectangular area taken up by the graphic user interface (i.e. of the rectangle formed by the rectangular area), in a direction running perpendicular to the rectangular area taken up by the graphic user interface, to the nearest side of the area taken up by the first section of the production parameter course view.

For example, the alternative view takes up a rectangular area on a graphic user interface which displays the alternative view as part of the graphic user surface.

According to an exemplary embodiment of the invention, the method further comprises the following:
obtaining and/or holding available production parameter information of the packaging system, wherein the production parameter information for the predefined production parameters of the packaging system in each case represents a course recorded for the predefined previous time period.

As disclosed above, a plurality of different components are often used in a packaging system. At least some of the components are for example configured to record at least one production parameter value of a production parameter of the packaging system and to send a representation of the at least one recorded production parameter value as production parameter information to the apparatus according to the invention (e.g. via a communication connection to the apparatus according to the invention).

Accordingly, obtaining production parameter information is for example understood as the production parameter information being received (e.g. by the apparatus according to the invention via a communication connection). Production parameter information should for example be understood as held available when it is stored in a memory (e.g. in a memory of the apparatus according to the invention). For example, production parameter information, which represents in each case production parameter values most recently recorded by the component(s) of the packaging system, is received and then stored in a memory continuously and/or at regular or irregular intervals.

For example, the production parameter information for each of the predefined production parameters in each case represents a plurality of production parameter values recorded during the predefined previous time period and a current production parameter value of the respective production parameter. In this case, a current production parameter value of the respective production parameter should for example be understood as the production parameter value most recently recorded in each case for this production parameter, which is represented by the production parameter information.

Furthermore, the production parameter information for each represented production parameter value can represent the associated recording time at which the production parameter value was recorded.

For example, the graphic representation of the courses and the current production parameter values of the predefined production parameters is based at least partially on the obtained and/or provided production parameter information and/or is determined at least partially based thereon.

According to an exemplary embodiment of the invention, the production parameter course view for each of the predefined production parameters in each case comprises a course curve associated with the respective production parameter, wherein each of the course curves in each case graphically represents the course of the production parameter associated with the respective course curve.

For example, such a course curve (e.g. each of the course curves) can be formed at least partially by a line or curve diagram. Such a line or curve diagram can be obtained for the predefined previous time period for example by connecting the points which represent the recorded production parameter values of the production parameter associated with the respective course curve and the associated recording times, which are represented by the production parameter information disclosed above for the predefined previous time period.

For example, each of the course curves in the first section of the production parameter course view represents a current production parameter value of the production parameter associated with the respective course curve. In this case, a current production parameter value of the respective production parameter, as disclosed above, should for example be understood as the production parameter value most recently recorded in each case for this production parameter, which is represented by the production parameter information.

According to an exemplary embodiment of the invention, the graphic user surface comprises a user input interface to activate the alternative view, to predefine and/or adjust the predefined production parameters and/or to predefine and/or adjust the predefined previous time period.

For example, the user input interfaces are displayed as part of the graphic user surface (e.g. by a graphic user interface of the apparatus according to the invention).

An example of a user input interface is for example an element of the user surface that can be activated and/or manipulated by a user input (e.g. by a touch input and/or a mouse input) such as a button, a control box or a slide control.

The user input interface to activate the alternative view is for example configured to cause the activating of the alternative view of the graphic user surface when it is activated by a corresponding user input. For example, the activating of the user input interface to activate the alternative view causes the alternative view to be displayed as part of the graphic user surface and/or the displaying of the alternative view is caused.

It is understood that the graphic user surface can also comprise a plurality of user input interfaces to activate the alternative view, wherein the alternative view, when it is activated by one of the user input interfaces, displays information associated with the respective user input interface and/or provides user input interfaces associated with the respective user input interface. As a result, the alternative view can serve to display different information and/or user input interfaces. For example, a user input interface can be provided to activate the alternative view with which diagnostic information of one or a plurality of components of the packaging system is associated such that the alternative view, when it is activated by this user input interface, displays diagnostic information of one or a plurality of components of the packaging system. A user input interface can also for example be provided to activate the alternative view which is associated with the user input interfaces to control one or a plurality of components of the packaging system such that the alternative view, when it is activated by this user input interface, provides user input interfaces to control one or a plurality of components of the packaging system.

The user input interface to predefine and/or adjust the predefined production parameters and/or the predefined previous time period is for example configured to enable the predefining and/or adjusting of the predefined production parameters and/or the predefined previous time period by a corresponding user input.

It is understood that additional user input interfaces may be part of the graphic user surface.

According to an exemplary embodiment of the invention, the graphic user surface is displayed and/or provided by a graphic user interface of a portable apparatus. For example, the apparatus according to the invention is a portable apparatus.

For example, a portable apparatus should be understood as an apparatus, whose external dimensions are smaller than 330 mm×250 mm×20 mm, preferably smaller than 250 mm×200 mm×15 mm, particularly preferably smaller than 160 mm×80 mm×8 mm.

Examples of a portable apparatus are a smartphone, a tablet computer or a notebook computer.

The exemplary embodiments and exemplary configurations of the present invention described above should also be understood to be disclosed in all combinations.

Further advantageous exemplary configurations of the invention can be inferred from the following detailed description of a number of exemplary embodiments of the present invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features contained in the drawings should in no way be deemed a necessary element of the present invention.

In the drawings:

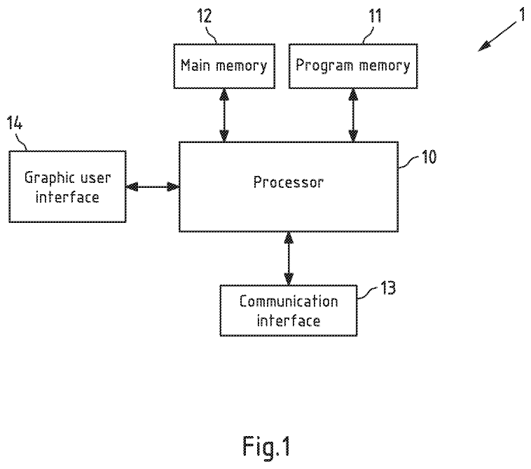

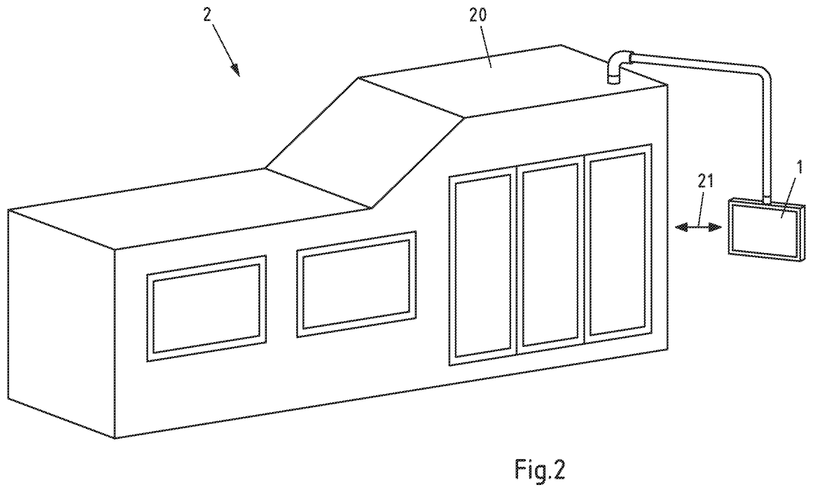

FIG. 1 shows a schematic representation an exemplary embodiment of an apparatus according to the invention;

FIG. 2 shows a schematic representation of an exemplary embodiment of a system according to the invention;

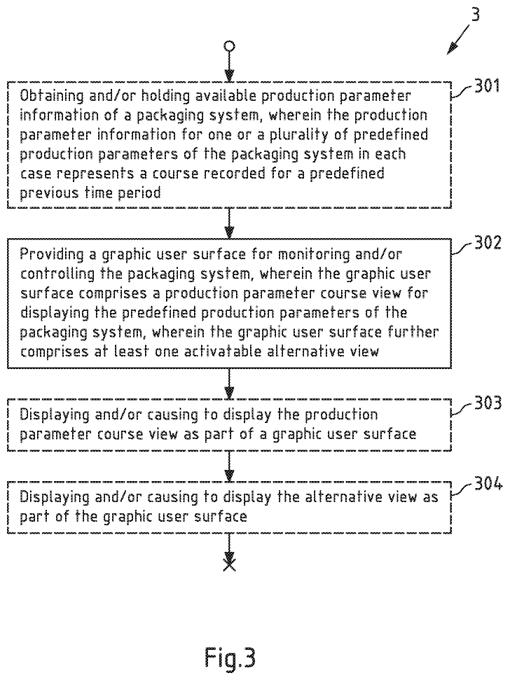

FIG. 3 shows a flow diagram of an exemplary embodiment of a method according to the invention;

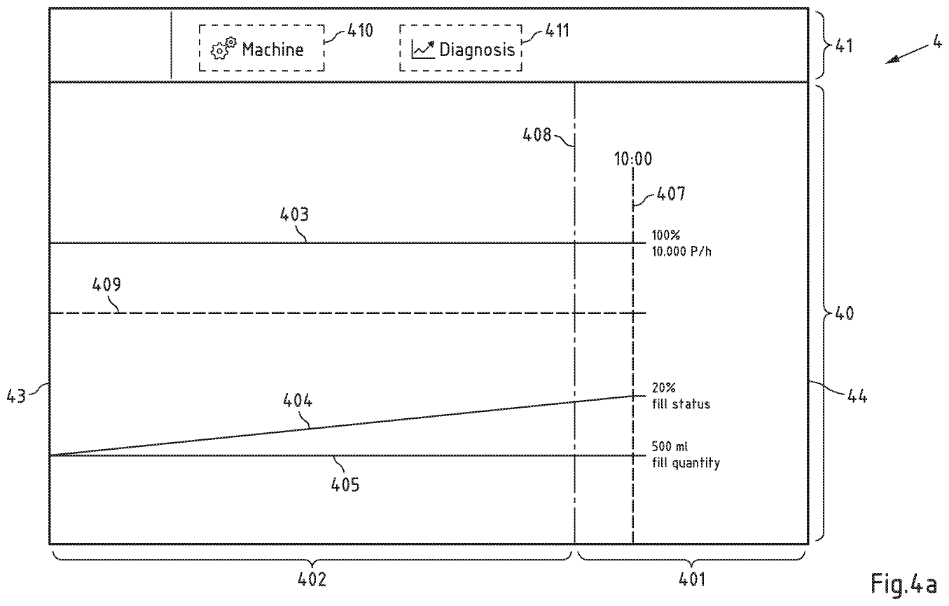

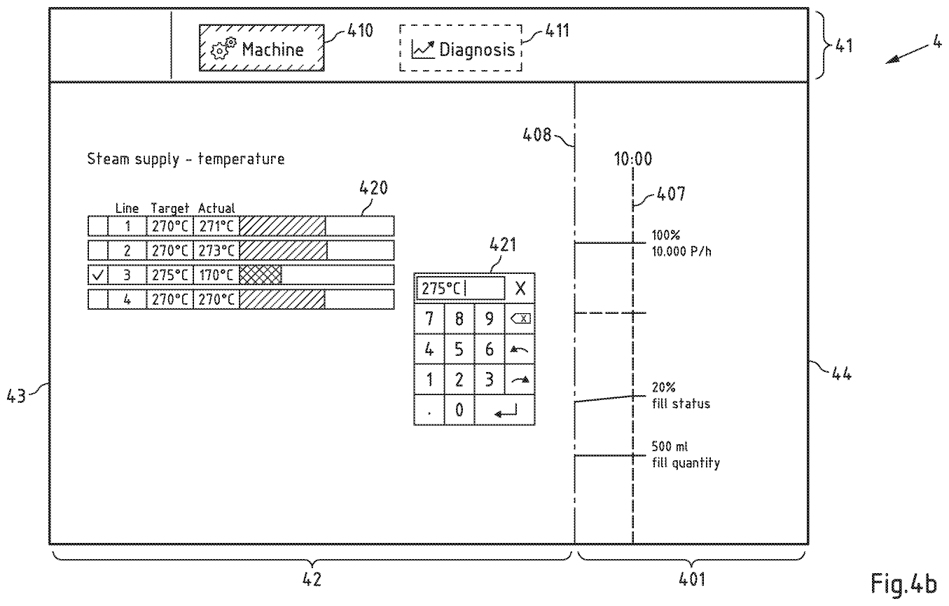

FIG. 4a shows an exemplary display of a graphic user surface with a production parameter course view;

FIG. 4b shows an exemplary display of a graphic user surface with an alternative view and a first section of a production parameter course view; and

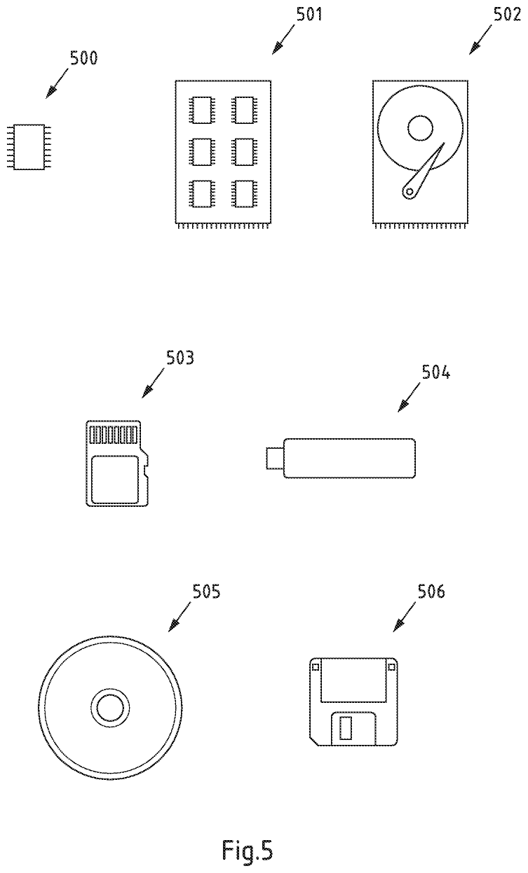

FIG. 5 shows exemplary embodiments of storage media.

### DETAILED DESCRIPTION OF A NUMBER OF EXEMPLARY EMBODIMENTS OF THE INVENTION

FIG. 1 is a schematic representation of an exemplary embodiment of an apparatus according to the invention. The apparatus according to the invention is represented as apparatus 1 in FIG. 1.

The apparatus comprises for example a processor 10 and connected to the processor 10 a first memory as a program and data memory 11, a second memory as a main memory 12 and a communication interface 13 and a graphic user interface 14.

A processor should for example be understood to be a microprocessor, a microcontrol unit, a microcontroller, a Digital Signal Processor (DSP), an Application-Specific Integrated Circuit (ASIC) or a Field Programmable Gate Array (FPGA). It should be understood that the apparatus 1 can also comprise a plurality of processors 10.

Processor 10 executes program instructions that are stored in the program memory 11 and stores for example interim results or the like in the main memory 12. The program memory 11 contains for example program instructions of a computer program according to the invention which comprises program instructions which cause the processor 10 to perform and/or control the method according to the invention (for example the method according to the flow chart 3 shown in FIG. 3) when the processor 10 executes these program instructions stored in the program memory 11.

Program memory 11 for example also contains the operating system of the apparatus which, on starting the apparatus, is, at least in some cases, loaded in the main memory 12 and executed by the processor 10. In particular, upon starting apparatus, at least a part of the core of the operating system is loaded in the main memory 12 and executed by processor 10.

An example of an operating system is a Windows, UNIX, Linux, Android, Apple iOS and/or Mac OS operating system. In particular, the operating system makes it possible to use the portable apparatus for data processing. For example, it administers tools such as a main memory and a program memory, provides fundamental functions among other things through programming interfaces with other computer programs and controls the executing of computer programs.

A program memory is for example a non-volatile memory such as a flash drive, a magnetic memory, an EEPROM memory (electrically erasable programmable read-only memory) and/or an optical memory. A main memory is for example a volatile or non-volatile memory, in particular a memory with random-access (RAM) such as a static RAM memory (SRAM), a dynamic RAM memory (DRAM), a ferroelectric RAM memory (FeRAM) and/or a magnetic RAM memory (MRAM).

The main memory 12 and the program memory 11 can also be formed as one memory. Alternatively, the main memory 12 and/or the program memory 11 can each be formed by a plurality of memories. Furthermore, the main memory 12 and/or the program memory 11 can also be part of the processor 10.

Processor 10 controls the communication interface 13. A communication interface can for example receive information according to a communication technique via a communication path and/or a communication connection and provide it to the processor 10 and/or receive information from the processor 10 and send it according to a communication technique via a communication path and/or a communication connection. Examples of such communication techniques are communication networks and their specifications such as Ethernet networks and/or WLAN networks and/or real-time Ethernet networks such as EtherCAT and/or mobile communication networks such as GSM, UMTS and/or LTE networks. An example of a communication interface is, accordingly, a network adapter such as an Ethernet and/or WLAN and/or EtherCAT and/or a mobile communication network adapter.

Furthermore, processor 10 controls the graphic user interface 14. For example, the graphic user interface 14 is configured to display a graphic user surface (e.g. a graphic user surface of a computer program run by the processor 10). For example, the graphic user interface 14 is a screen such as a touch-sensitive screen.

The components 10 to 14 of the apparatus 1 are for example connected with one another for communication and/or operating purposes via one or a plurality of bus systems (for example one or a plurality of serial and/or parallel bus connections).

It is understood that, in addition to the components 10 to 14, the apparatus 1 can comprise further components such as for example input and output means (e.g. a keyboard and/or a mouse).

The apparatus 1 can for example be formed as a portable apparatus (e.g. as a tablet computer).

FIG. 2 is a schematic representation of an exemplary embodiment of a system 2 according to the invention with a packaging system 20 and an apparatus 1, which is fastened to a holder of the packaging system 20, and can communicate (e.g. receive and/or send information such as production parameter information) via a communication connection 21 with the packaging system 20 and/or components of the packaging system 20. It is assumed below that the apparatus 1 corresponds to the apparatus 1 from FIG. 1.

The packaging system 20 is for example a beverage filling system and/or a part of a beverage filling system. A large number of different components are frequently used in such systems, for example heating systems (for example heating systems for ultra-high heating of the filled product), filling machines, applicators for attaching closures and/or beverage straws, switch points, case packers and cartoners.

At least some of the components of the packaging system 20 are configured to record at least one production parameter value of a production parameter of the packaging system 20 and to send a representation of the at least one recorded production parameter value as production parameter information to the apparatus 1 via the communication connection 21.

In this case, a production parameter of the packaging system 20 is for example understood as a parameter characteristic of the status of the packaging system 20 and/or a production process executed by the packaging system 20. Examples of such production parameters are a filling quantity per package, a temperature (e.g. a temperature of the filling material), a fill status or a fill level (e.g. a fill status of a packaging material magazine of the packaging system or a fill level of a product tank such as a filling material tank of the packaging system), a total system performance of the packaging system 20 and/or a performance of one or a plurality of components of the packaging system 20 (e.g. a number of packages per hour processed by the packaging system and/or the component(s)), a pressure (e.g. the pressure of a pressurised air supply of the packaging system 20 and/or a component of the packaging system 20), a flow (e.g. the flow of a cooling fluid in a cooling device of the packaging system 20), a time specification (e.g. an indication of the remaining time of an ongoing process such as a cleaning process of the packaging system 20 and/or a component of the packaging system 20), and/or a volume (e.g. the volume of the filling material remaining in a product tank such as a filling material tank of the packaging system).

FIG. 3 shows a flow diagram 3 with steps of an exemplary embodiment of a method according to the invention. It is assumed below by way of example that the steps 301 to 304 of the flow chart 3 are performed by the apparatus 1, which is part of the system 2 (see FIG. 2).

In an optional step 301, production parameter information of the packaging system 20 is obtained at the apparatus 1 and/or held available by the apparatus 1, wherein the production parameter information for one or a plurality of predefined production parameters of the packaging system 20 in each case represents a course recorded for a predefined previous time period.

For example, the production parameter information of the packaging system 20 is received in step 301 at least partially by the communication interface 13 via the communication 21 from the packaging system. Alternatively or additionally, the production parameter information of the packaging system 20 can be stored at least partially in program memory 11 of the apparatus 1.

For example, production parameter information, which represents in each case production parameter values most recently recorded by the component(s) of the packaging system, is received by the communication interface 13 via the communication connection 21 and then stored in a program memory 11 continuously and/or at regular or irregular intervals. Accordingly, the production parameter information for each of the predefined production parameters for example represents a plurality of production parameter values of the respective production parameter recorded during the predefined previous time period.

In a step 302, a graphic user surface is provided for monitoring and/or controlling the packaging system 20 by the portable apparatus 1, wherein the graphic user surface comprises a production parameter course view to display one or a plurality of predefined production parameters of the packaging system, and wherein the graphic user surface also comprises at least one alternative view that can be activated.

For example, the graphic user surface is provided by the portable device 1 by it being displayed at least partially by the graphic user interface 14.

The graphic user surface can comprise different views and elements, which can be displayed at least partially at the same time as part of the graphic user surface. It is understood that at least in some embodiments at least some views and elements of the user surface can be displayed only alternatively as part of the user surface. In this case, the views and elements of the graphic user surface should for example be understood as displayed when they are visible to a user (e.g. are visibly displayed to a user by a graphic user interface).

Exemplary displays of a graphic user surface 4 are in FIGS. 4a and 4b which are displayed by the graphic user interface 14 when the graphic user surface 4 provides the graphic user surface 4 in step 302. It is assumed below that the graphic user interface 14 in step 302 provides the graphic user surface 4 from FIGS. 4a and/or 4b.

In an optional step 303, the production parameter course view is displayed as part of the graphic user surface and/or displaying of the production parameter course view is caused. For example, the production parameter course view is displayed as part of the graphic user surface as default as soon as the graphic user surface is provided by the graphic user interface 14.

The production parameter course view graphically represents for each of the predefined production parameters at least one course of the respective production parameter in the predefined previous time period and the respective current production parameter value. A respective representation of the predefined production parameters and/or the predefined previous time period is for example stored in a memory (e.g. in program memory 11 or main memory 12).

The graphic user surface 4 is represented with the production parameter course view 40 in FIG. 4a. As emerges from FIG. 4a, the production parameter course view 40 is for example displayed in a part of the graphic user surface 4 below a task or status list 41, which is also part of the user surface 4.

The production parameter course view 40 comprises a first section 401 and a second section 402.

The second section 402 for example comprises a course diagram, which represents the recorded courses 403-405 of the predefined production parameters in the predefined previous time period, which are represented by the product parameter information obtained and/or held available in step 301.

By way of example in the second section 402, a recorded course of the system performance in package per hour is represented by the course curves 403, a recorded course of a fill status of a packaging material magazine by the course curves 404 and a recorded course of the fill quantity per package by the course curves 405. For example, the different courses are represented in the course diagram as overlapping course curves (see 403-405) with a common X-axis 406.

The first section 401 comprises for example a graphic representation of the current production parameter values of the predefined production parameters. In this case, the current production parameter value of a production parameter should for example be understood as the production parameter value most recently recorded in each case for this production parameter, which is represented by the production parameter information obtained and/or held available in step 301. The graphic representation of the current production parameter values of the predefined production parameters is for example highlighted in FIG. 4a by a line 407 and the label “10:00”, which displays the current time and/or the associated recording time.

The transition between the first section 401 and the second section 402 is indicated in FIG. 4a by a dashed line 408. As emerges from FIG. 4a, the first section 401 of the production parameter course view 40 is located outside of the centre of the user surface 4 and the production parameter course view 40 extends from the side delimitation 43 of the user surface 4 in a direction running perpendicular to the side delimitation 43 to the side delimitation 44 of the user surface 4.

Furthermore, the user surface 4 can comprise one or a plurality of user input interfaces, for example to activate the alternative view and/or to predefine and/or to adjust the predefined production parameters and/or the predefined previous time period. An example of a user input interface is an element of the user surface 4 that can be activated and/or manipulated by a user input (e.g. by a touch input and/or a mouse input) such as a button, a control box or a slide control.

Two user input interfaces 410 and 411 are represented by way of example in FIG. 4a to activate the alternative view as part of the task and/or status list 41. Furthermore, a user input interface 410 can also for example be provided to activate the alternative view with which machine information and user input interfaces are associated to control one or a plurality of machine components of the packaging system such that the alternative view, when it is activated by this user input interface 410, displays machine information and provides user input interfaces to control one or a plurality of machine components of the packaging system 20. The user input interface 411 is for example associated with diagnostic information such that the alternative view, when it is activated by the user input interface 411, displays corresponding diagnostic information of one or a plurality of components of the packaging system 20.

In an optional step 304, the alternative view is displayed as part of the graphic user surface and/or displaying of the alternative view is caused.

For example, the alternative view is only displayed when it is activated. For example, a user can activate one of the user input interfaces 410 or 411 by a corresponding user input to trigger the displaying of the alternative view as part of the graphic user surface according to step 304. Depending on the user input interface that triggers the displaying of the alternative view, the alternative view can for example display different information (e.g. machine information for user input interface 410 and diagnostic information for user input interface 411).

The production parameter course view and the alternative view are configured such that the alternative view is displayed in step 304, when the alternative view is activated, such that the alternative view only partially covers the production parameter course view and a first section of the production parameter course view continues to be displayed with the graphic representations of the current production parameter values of the predefined production parameters.

The graphic user surface 4 is represented in FIG. 4b with the alternative view 42 and the first section 401 of the production parameter course view 40. The alternative view 42 and the first section 401 of the production parameter course view are displayed in a part of the graphic user surface 4 below the task or status list 41, which is also part of the user surface 4.

It is assumed by way of example below that the alternative view 42 was activated by the user input interface 410. Accordingly, the user input interface 410 is highlighted in FIG. 4b and the alternative view 42 displays by way of example machine information 420 for “steam supply—temperature” of a plurality of machine components of the packaging system 20 and provides a user input interface 421 to control the machine components.

As emerges from FIG. 4b, the alternative view 42 extends from the side delimitation 43 of the user surface 4 in a direction running perpendicular to the side delimitation 43 of the user surface 4 to the nearest side delimitation of the first section 401 of the production parameter course view 40, which is represented by the dashed line 408 such that the alternative view 42 covers at least partially the production parameter course view 40 and the first section 401 of the production parameter course view 40 continues to be displayed (i.e. at the same time as the alternative view 42) with the graphic representations of the current production parameter values of the predefined production parameters.

Since the first section 401 of the production parameter course view 40 is located outside of the centre of the user surface 4, the alternative view 42 may cover more than half of the production parameter course view 40 without the first section 401 of the production parameter course view 40 being covered. Accordingly, more than half of the production parameter course view 40 is available for the alternative view 42 without the user losing the view of the current status of the packaging system in the form of the current production parameter values of the predefined production parameters displayed in the first section 401 of the production parameter course view 40. As a result, the user can, even when the alternative view 42 is displayed, react particularly quickly to status changes, if this is required.

FIG. 5 shows exemplary embodiments of storage media on which an exemplary embodiment of a computer program according to the invention can be stored. The storage medium can for example be a magnetic, electric, optic and/or other type of storage medium. The storage medium can for example be part of a processor (e.g. processor 10 of the portable apparatus 1 from FIG. 1), for example a (non-volatile or volatile) program memory of the processor or a part of this. Exemplary embodiments of a storage medium are a flash memory 500, an SSD hard drive 501, a magnetic hard drive 502, a memory card 503, a memory stick 504 (for example a USB stick), a CD-ROM or DVD 505 or a diskette 506.

The exemplary embodiments of the present invention described in this specification should also be understood as being disclosed in all combinations with each other. In particular, the description of a feature included by an embodiment, provided the opposite is not explicitly explained, should also not be understood in the present case as the feature being necessary or essential for the function of the exemplary embodiment. The sequence of the method steps in the individual flow diagrams outlined in this specification is not absolutely necessary, alternative sequences of the method steps are conceivable, unless otherwise indicated. The method steps can be implemented in a different manner, thus an implementation in software (by program instructions), hardware or a combination of the two in order to implement the method steps is conceivable.

Terms used in the claims such as “comprise”, “have”, “contain”, “include” and the like do not exclude additional elements or steps. The wording “at least partially” includes both the case of “partially” and also the case of “fully”. The wording “and/or” should be understood as both the alternative and the combination being disclosed, i.e. “A and/or B” means “(A) or (B) or (A and B)”. A plurality of units, individuals or the like means multiple units, individuals or the like in the context of this specification. The use of the indefinite article does not exclude a plurality. An individual device can perform the functions of a plurality of units or devices mentioned in the claims. Reference numerals indicated in the claims should not be considered as limitations of the means and steps used.

1. A method comprising:
providing a graphic user surface for monitoring or controlling a packaging system, wherein the graphic user surface comprises a production parameter course view for displaying one or a plurality of predefined production parameters of the packaging system, wherein the production parameter course view for each of the predefined production parameters graphically represents at least one course of the respective production parameter in a previous time period and the respective current production parameter value, wherein the graphic user surface further comprises at least one alternative view that can be activated and wherein the production parameter course view and the alternative view are configured such that the alternative view is displayed when the alternative view is activated in such a way that the alternative view only partially covers the production parameter course view and a first section of the production parameter course view is displayed with the graphic representations of the current production parameter values of the predefined production parameters, wherein the production parameter course view for each of the predefined production parameters in each case comprises a course curve associated with the respective production parameter, wherein each of the course curves in each case graphically represents the course of the production parameter associated with the respective course curve and wherein each of the course curves in the first section of the production parameter course view represents a current production parameter value of the production parameter associated with the respective course curve.

2. The method according to claim 1, further comprising:
displaying or causing to display the alternative view as part of the graphic user surface.

3. The method according to claim 1, wherein the alternative view is only displayed as part of the user surface when it is activated.

4. The method according to claim 1, further comprising:
displaying or causing to display at least one of the production parameter course view or the first section of the production parameter course view as part of the graphic user surface.

5. The method according to claim 1, wherein at least the first section of the production parameter course view is displayed permanently as part of the user surface.

6. The method according to claim 1, wherein the first section of the production parameter course view is located outside of the centre of the graphic user surface.

7. The method according to claim 1, wherein the production parameter course view extends at least in a direction from a side delimitation of the graphic user surface to an opposing side delimitation of the graphic user surface,
and wherein the alternative view extends at least in a direction from a side delimitation of the graphic user surface to the first section of the production parameter course view.

8. (canceled)

9. The method according to claim 1, further comprising:
at least one of obtaining or holding available production parameter information of the packaging system, wherein the production parameter information for the predefined production parameters of the packaging system in each case represents a course recorded for the predefined previous time period.

10. (canceled)

11. The method according to claim 1, wherein each of the course curves is at least partially formed by a line or curve diagram.

12. The method according to claim 1, wherein the graphic user surface comprises at least one of a user input interface to activate the alternative view, to predefine or adjust the predefined production parameters or to predefine or adjust the predefined previous time period.

13. A non-transitory computer readable storage medium on which a computer program is stored, the computer program comprising program instructions which cause a processor to perform or control the method according to claim 1, when the computer program is executed by the processor.

14. An apparatus comprising at least one processor and at least one memory including computer program code, wherein the at least one memory and the computer program code are configured to, together with the at least one processor, cause the apparatus to perform or control:
providing a graphic user surface for monitoring or controlling a packaging system, wherein the graphic user surface comprises a production parameter course view for displaying one or a plurality of predefined production parameters of the packaging system, wherein the production parameter course view for each of the predefined production parameters graphically represents at least one course of the respective production parameter in a previous time period and the respective current production parameter value, wherein the graphic user surface further comprises at least one alternative view that can be activated and wherein the production parameter course view and the alternative view are configured such that the alternative view is displayed when the alternative view is activated in such a way that the alternative view only partially covers the production parameter course view and a first section of the production parameter course view is displayed with the graphic representations of the current production parameter values of the predefined production parameters, wherein the production parameter course view for each of the predefined production parameters in each case comprises a course curve associated with the respective production parameter, wherein each of the course curves in each case graphically represents the course of the production parameter associated with the respective course curve and wherein each of the course curves in the first section of the production parameter course view represents a current production parameter value of the production parameter associated with the respective course curve.

15. (canceled)

16. The apparatus according to claim 14, wherein the at least one memory and the computer program code are further configured to, together with the at least one processor, cause the apparatus to further perform or control:
displaying or causing to display the alternative view as part of the graphic user surface.

17. The apparatus according to claim 14, wherein the alternative view is only displayed as part of the user surface when it is activated.

18. The apparatus according to claim 14, wherein the at least one memory and the computer program code are further configured to, together with the at least one processor, cause the apparatus to further perform or control:
displaying or causing to display at least one of the production parameter course view or the first section of the production parameter course view as part of the graphic user surface.

19. The apparatus according to claim 14, wherein at least the first section of the production parameter course view is displayed permanently as part of the user surface.

20. The apparatus according to claim 14, wherein the first section of the production parameter course view is located outside of the centre of the graphic user surface.

21. The apparatus according to claim 14, wherein the production parameter course view extends at least in a direction from a side delimitation of the graphic user surface to an opposing side delimitation of the graphic user surface, and, wherein the alternative view extends at least in a direction from a side delimitation of the graphic user surface to the first section of the production parameter course view.

22. The apparatus according to claim 14, wherein the at least one memory and the computer program code are further configured to, together with the at least one processor, cause the apparatus to further perform or control:
at least one of obtaining or holding available production parameter information of the packaging system, wherein the production parameter information for the predefined production parameters of the packaging system in each case represents a course recorded for the predefined previous time period.

23. The apparatus according to claim 14, wherein each of the course curves is at least partially formed by a line or curve diagram.

24. The apparatus according to claim 14, wherein the graphic user surface comprises at least one of a user input interface to activate the alternative view, to predefine or adjust the predefined production parameters or to predefine or adjust the predefined previous time period.
